(19) United States
(12) Patent Application Publication
(10) Pub. No.: US 2010/0010798 A1
(43) Pub. Date: Jan. 14, 2010

(54) Modeling of variations in drain-induced barrier lowering (DIBL)

(75) Inventors: Vineet Wason, Santa Clara, CA (US); Sushant Suryagandh, Sunnyvale, CA (US); Zhi-Yuan Wu, Union City, CA (US); Priyanka Chiney, Sunnyvale, CA (US); Niraj Subba, Sunnyvale, CA (US)

Correspondence Address: HAMILTON & TERRILE, LLP - AMD, P.O. BOX 203518, AUSTIN, TX, 78720, US

(73) Assignee: Advanced Micro Devices, Inc.

(21) Appl. No.: 12/217,793

(22) Filed: Jul. 9, 2008

(51) Int. Cl. G06F 17/50

(52) U.S. Cl. 703/14

(57) ABSTRACT

The present method is a method of modeling Drain-Induced Barrier Lowering (DIBL) in a transistor model, the transistor model being based on a MOSFET transistor. The transistor model includes a base, a source, a drain, a gate, and a gate terminal. In the present method, a voltage is applied to the gate terminal, a voltage is applied to the drain, and an electrical potential is applied between the gate terminal and gate. The magnitude of electrical potential applied between the gate terminal and gate is varied in proportion to the magnitude of voltage applied to the drain.

### BACKGROUND OF THE INVENTION

1. Field of the Invention

This invention relates generally to modeling of transistors, and more particularly, to the accurate variation modeling of Drain-Induced Barrier Lowering (DIBL) of a transistor.

2. Discussion of the Related Art

In a typical approach in modeling an MOS transistor 20 including a p-type body 22, n-type source 24 and drain 26, a gate insulator 28, and a gate 30 having gate terminal 32 connected thereto (FIG. 1), using selected data (for example current-voltage (IV) operational characteristics) taken from the actual transistor 20 to be modeled, one loads this data into a software program which also contains a (public domain) transistor model, for example a BSIM MOSFET model 40 including a p-type body 42, n-type source 44 and drain 46, a gate insulator 48, and a gate 50 having gate terminal 52 connected thereto (FIG. 2). Parameters of the transistor model 40 are then varied with the goal of having the model operational characteristics match those corresponding operational characteristics of the actual transistor 20.

In FIG. 3, the squares (greatly reduced in number for clarity) illustrate data for an actual transistor 20 to be modeled, showing actual drive current Idrive vs. steps in drain-source voltage Vds at various values of voltage Vgs1, Vgs2, Vgs3, resulting from respective increasing voltages V1, V2, V3 applied to terminal 32. The goal is to provide a transistor model 40 which has operational characteristics which substantially match this data. As stated above, to achieve this, parameters of the transistor model 40 are varied until “best” matches (illustrated by the continuous lines) are provided to the actual data. This provides the transistor base model.

As noted above, the transistor base model 40 has a number of parameters that can be vary to match operational characteristics. However, there are certain effects which are seen in the actual measured data which cannot be properly modeled by varying the model parameters, which is a modeling deficiency. Since the present modeling approach cannot model some of the affects seen in actual devices, simulations will show discrepancies in some of the parameters critical to circuit operation.

A problem area of such an approach is the inability to adequately model variations in Drain-Induced Barrier Lowering (DIBL) as seen in actual transistors. DIBL is a phenomenon which may be described as follows. The combined charge in the depletion region of the device and that in the channel of the device is balanced by three e charges: the gate 30, the source 24 and the drain 26. As drain voltage is increased, the depletion region of the p-n junction between the drain 26 and body 22 increases in size and extends under the gate 30, so the drain 26 assumes a greater portion of the burden of balancing depletion region charge, leaving a smaller burden for the gate 30. As a result, the charge present on the gate 30 retains charge balance by attracting more carriers into the channel between the source 24 and the drain 26, an effect equivalent to lowering the threshold voltage Vt of the device 20. In effect, the channel becomes more attractive for electrons, and the potential energy barrier for electrons in the channel is lowered. Hence the term “barrier lowering” is used to describe these phenomena. Mathematically, the magnitude of DIBL for a given transistor is Vtlin minus Vtsat.

Fabricated transistors are subject to process induced variations which cannot be controlled. For example, a series of such actual transistors may have slightly different channel lengths or threshold voltages, causing different operating characteristics from transistor to transistor. Consequently it is desirable to build these variations into the transistor model so that one will know how the fabricated transistor will perform with these random variations.

In furtherance thereof, over a number of such transistors, these transistors are measured for parameters such as Idsat, Vdsat, Vtlin and other electrical performance characteristics as chosen. For a given set of transistors, this provides a Gaussian distribution for each of these measured parameters. Then, using propagation of variance techniques on that data, Gaussian distributions for channel length L, channel width W and threshold voltage Vt of that modeled transistor are provided, which may be varied to capture in the model various performance parameters in the actual transistors.

While a transistor model, by varying L, W and Vt, can capture for example variations in Idsat, Vdsat, and Vtlin of actual transistors, it cannot be used to model variations in DIBL since these parameters would affect Vtsat, and Vtlin almost equally unless their dependence on L, W and Vt are greatly different. Also, there are other parameters available to model DIBL (such as dvtp0 and dvtp1). However, when these parameters go beyond that limited range, change in DIBL becomes insensitive to further variations in these parameters, i.e., varying these model-parameters does not provide accurate representation of actual variations in DIBL as measured in transistors. This issue is more prominent for longer channel lengths L where the model is unable to capture the spread in DIBL, and hence the spread in output resistance Rout. For shorter channel lengths L, the existing variation wrapper is able to capture the spread in DIBL and hence Rout. Since analog circuits typically use longer channel lengths to get higher performance, it is important to capture the effects seen with longer channel length to improve manufacturing yield.

Furthermore, the approach described above is typically model-dependent since the sensitivity of DIBL to BSIM parameters varies depending upon the base model. This is a significant disadvantage since variation models must be changed each time the base model changes.

Therefore, what is needed is an approach for accurately modeling variations in Drain-Induced Barrier Lowering (DIBL) as seen in actual transistors, which is in addition not transistor model-specific dependent.

### SUMMARY OF THE INVENTION

Broadly stated, the present method is a method of modeling Drain-Induced Barrier Lowering (DIBL) in a transistor model, the transistor model comprising a base, a source, a drain, a gate, and a gate terminal. The method comprises applying a voltage to the gate terminal, applying a voltage to the drain, applying an electrical potential between the gate terminal and gate, varying the magnitude of voltage applied to the drain, and varying the magnitude of electrical potential applied between the gate terminal and gate, the magnitude of electrical potential applied between the gate terminal and gate being dependent on the magnitude of voltage applied to the drain.

The present invention is better understood upon consideration of the detailed description below, in conjunction with the accompanying drawings. As will become readily apparent to those skilled in the art from the following description, there is shown and described an embodiment of this invention simply by way of the illustration of the best mode to carry out the invention. As will be realized, the invention is capable of other embodiments and its several details are capable of modifications and various obvious aspects, all without departing from the scope of the invention. Accordingly, the drawings and detailed description will be regarded as illustrative in nature and not as restrictive.

### BRIEF DESCRIPTION OF THE DRAWINGS

The novel features believed characteristic of the invention are set forth in the appended claims. The invention itself, however, as well as said preferred mode of use, and further objects and advantages thereof, will best be understood by reference to the following detailed description of an illustrative embodiment when read in conjunction with the accompanying drawings, wherein:

FIG. 1 is a cross-sectional view of a MOSFET transistor to be modeled;

FIG. 2 is a schematic view of a model of the transistor of FIG. 1;

FIG. 3 is a graph illustrating performance characteristics of the model of FIG. 3;

FIG. 4 is a cross-sectional view of a MOSFET transistor to be modeled, with the model incorporating the present invention;

FIG. 5 is a schematic view of a model of the transistor of FIG. 4, incorporating the present invention;

FIG. 6 is a graph illustrating performance characteristics of the model of FIG. 5; and

FIGS. 7 and 8 are graphs illustrating performance of previous and present modeling.

### DETAILED DESCRIPTION

Reference is now made in detail to a specific embodiment of the present invention which illustrates the best mode presently contemplated by the inventors for practicing the invention.

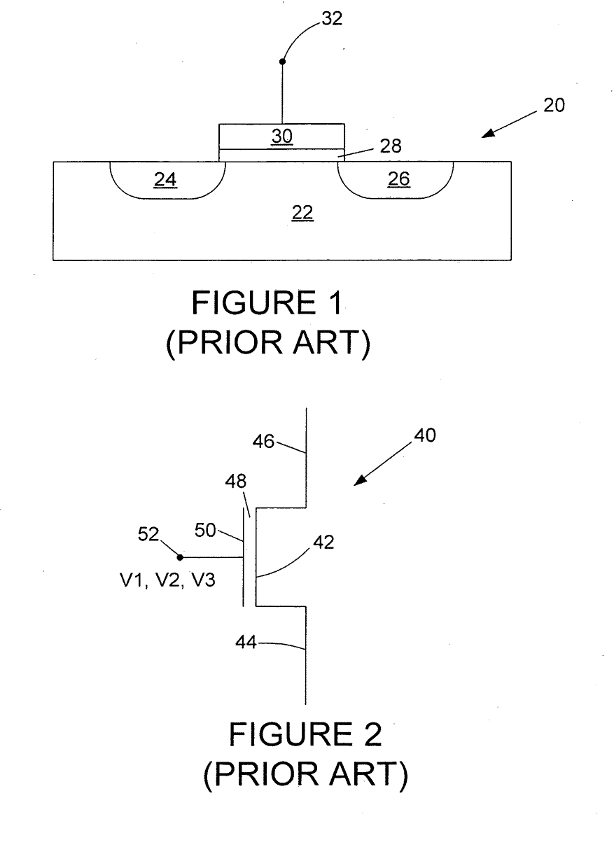

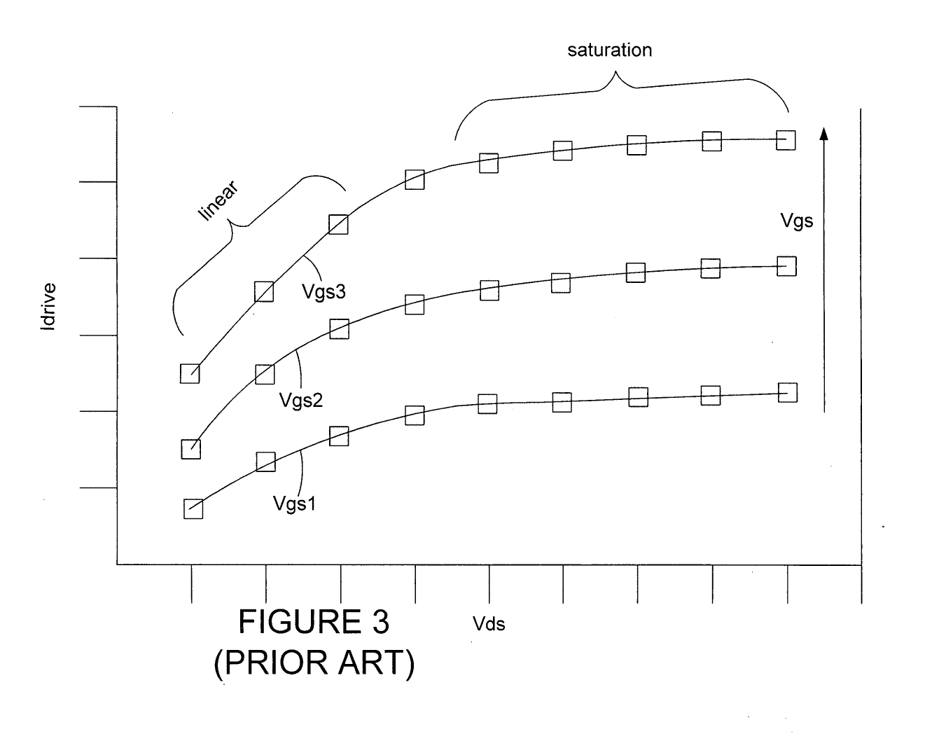

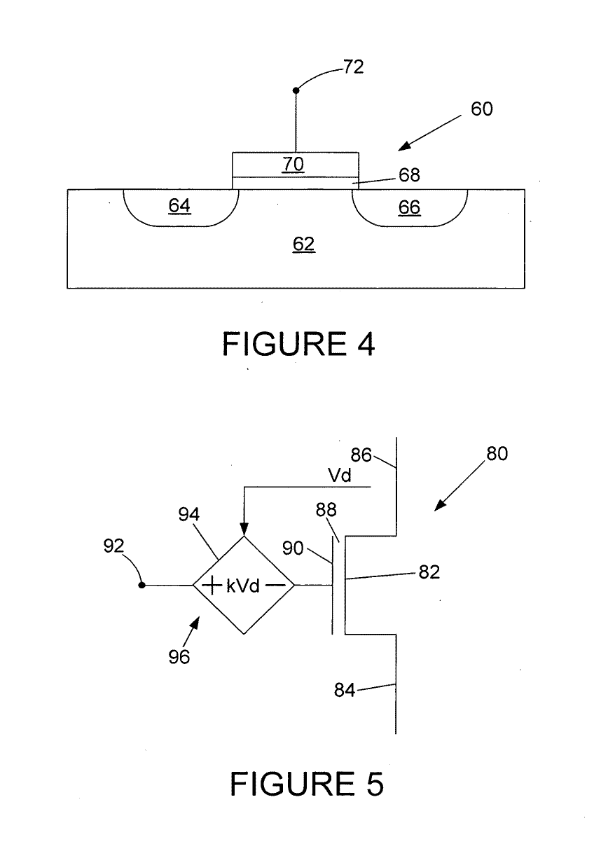

FIG. 4, similar to FIG. 1, shows an MOS transistor 60 to be modeled, the transistor 60 including a p-type body 62, n-type source 64 and drain 66, a gate insulator 68, and a gate 70 having gate terminal 72 connected thereto. The transistor 60 is modeled as in the prior art (FIG. 5), providing transistor model 80 including a p-type body 82, n-type source 84 and drain 86, a gate insulator 88, and a gate 90 having gate terminal 92 connected thereto. However, in the present approach, a drain Voltage Dependent Voltage Source (VDVS) 94 is provided between the gate terminal 92 and gate 90 of the model 80. As such, the magnitude of electrical potential of the VDVS 94 is dependent on the magnitude of voltage applied to the drain 86 of the transistor model 80. In this particular embodiment, the magnitude of electrical potential of the VDVS 94 is directly proportional to the magnitude of voltage applied to the drain 86 of the transistor model 80 (i.e., V(VDVS)=kVd) and is situated in a region 96 between the gate terminal 92 and gate 90 so that the electrical potential of the VDVS 94 is applied from higher to lower potential in the direction from the gate terminal 92 to the gate 90.

In an example of use of the transistor model 80, a voltage is applied to the gate terminal 92, a voltage is applied to the drain 86, the source 84 is at 0V, and an electrical potential (the magnitude of which is directly proportional to the magnitude of the drain voltage) is applied by the VDVS 94 from higher to lower potential in the direction from the gate terminal 92 to the gate 90. With variations in voltage applied to the drain 86, the potential applied by the VDVS 94 is a function of the drain voltage Vd, resulting in a higher gate overdrive being provided for a higher drain-source bias. For example, with 100 mv applied to gate terminal 92 and VDVS 94 providing 20 mv (source voltage at 0), Vgs=80 mv, whereas in the prior art, Vgs=100 mv.

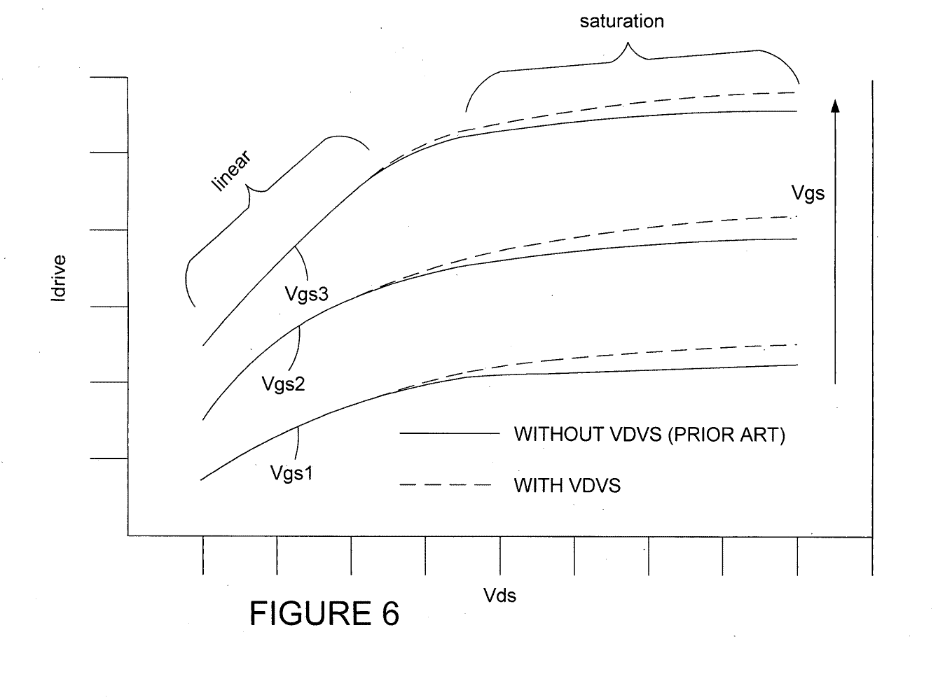

The effect of the present approach is illustrated in FIG. 6. The potential applied by the VDVS 94 minimally impacts the linear regions of the IV curves, but substantially impacts the saturation regions thereof. Thus, variation of the potential applied by VDVS 94 (directly proportional to voltage applied to the drain 86) substantially varies Vtsat but only minimally varies Vtlin. With DIBL being Vtlin minus Vtsat, and assuming that Vtsat is the threshold voltage needed to turn the transistor model 80 on, by controlling Vtsat in accordance with the drain voltage, the voltage Vt needed to turn on the transistor model 80 is varied in accordance with variations in drain voltage, mimicking the change in Vt due to DIBL.

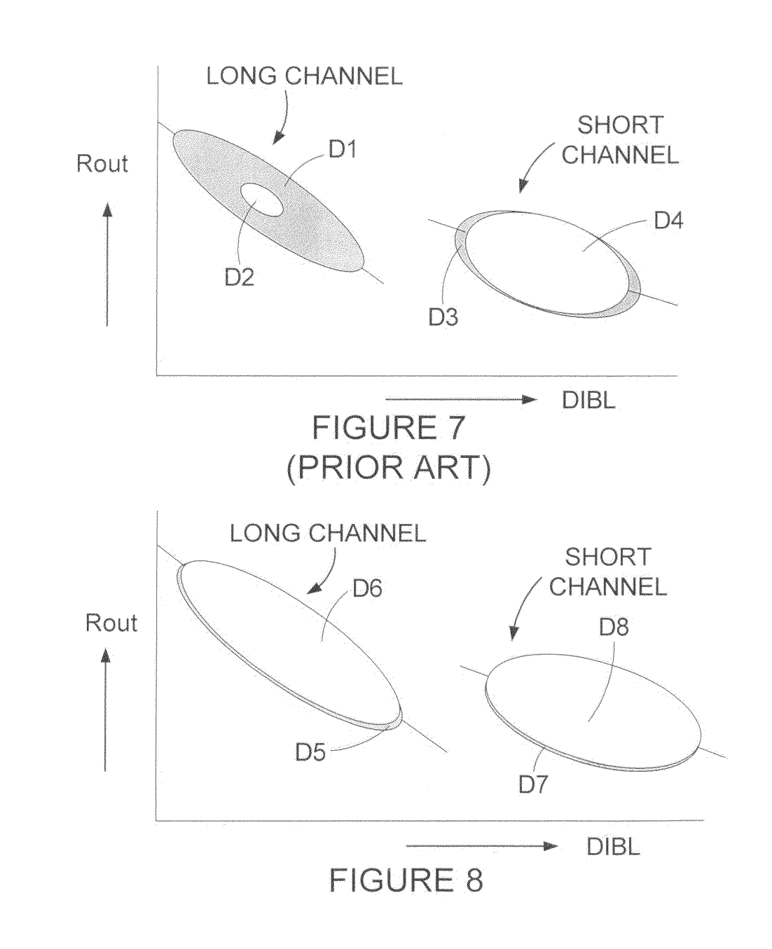

FIG. 7 is a graph illustrating variations in Rout vs. DIBL comparing actual device data D1 with device model data D2 for a long channel device and model, and comparing actual device data D3 with device model data D4 for a short channel device and model, using the prior art approach. As will be seen, with the prior approach, short channel devices are capable of being substantially accurately modeled for DIBL, i.e. the spread of data of the actual devices is very similar to the spread of data of the model. However, for long channel devices, this is not the case, i.e., the spread of data of the actual devices is much greater than the spread of data of the model.

FIG. 8 is a graph illustrating variations in Rout vs. DIBL comparing actual device data D5 with device model data D6 for a long channel device and model, and comparing actual device data D7 with device model data D8 for a short channel device and model, using the present approach. As will be seen, short channel devices are capable of being even more accurately modeled for DIBL, i.e. the spread of data of the actual devices is very close to the spread of data of the model. Furthermore, long channel devices are also capable of being very accurately modeled i.e. the spread of data of the actual devices is very close to the spread of data of the model.

As noted above, the approach described in the prior art is typically model-dependent since the sensitivity of DIBL to BSIM parameters varies depending upon the base model. This is a significant disadvantage since variation models must be changed each time the base model changes. The present approach is independent of the base model. The variation model does not need to be regenerated each time the base model changes. Since this approach provides proper modeling variations in DIBL and is also model-independent, this approach is greatly beneficial to circuit designers, especially in the design of circuits that are highly sensitive to variations and mismatch such as analog circuits and SRAM cells. Furthermore, this approach can be applied to other applications as well, particularly in cases where it is difficult to capture the effect using standard BSIM models.

The foregoing description of the embodiment of the invention has been presented for purposes of illustration and description. It is not intended to be exhaustive or to limit the invention to the precise form disclosed. Other modifications or variations are possible in light of the above teachings.

The embodiment was chosen and described to provide the best illustration of the principles of the invention and its practical application to thereby enable one of ordinary skill of the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A method of modeling Drain-Induced Barrier Lowering (DIBL) in a transistor model, the transistor model comprising a base, a source, a drain, a gate, and a gate terminal, the method comprising applying an electrical potential between the gate terminal and gate.

2. The method of claim 1 wherein the method further comprises applying an electrical potential from higher to lower potential in the direction from the gate terminal to the gate.

3. The method of claim 2 and further comprising applying a voltage to the drain of the transistor model.

4. The method of claim 2 and further comprising applying a voltage to the gate terminal of the transistor model.

5. The method of claim 2 wherein the magnitude of the electrical potential is dependent on the magnitude of a voltage applied to the drain of the transistor model.

6. The method of claim 2 wherein the magnitude of the electrical potential is proportional to the magnitude of a voltage applied to the drain of the transistor model.

7. The method of claim 2 wherein the magnitude of the electrical potential is directly proportional to the magnitude of voltage applied to the drain of the transistor model.

8. A method of modeling Drain-Induced Barrier Lowering (DIBL) in a transistor model, the transistor model comprising a base, a source, a drain, a gate, and a gate terminal, the method comprising:
applying a voltage to the gate terminal;
applying a voltage to the drain;
applying an electrical potential between the gate terminal and gate;
varying the magnitude of voltage applied to the drain; and
varying the magnitude of electrical potential applied between the gate terminal and gate, the magnitude of electrical potential applied between the gate terminal and gate being dependent on the magnitude of voltage applied to the drain.

9. The transistor model of claim 8 wherein the magnitude of the electrical potential is proportional to the magnitude of the voltage applied to the drain of the transistor model.

10. The transistor model of claim 8 wherein the magnitude of the electrical potential is directly proportional to the magnitude of the voltage applied to the drain of the transistor model.

11. A transistor model comprising a base, a source, a drain, a gate, a gate terminal, and a region between the gate terminal and gate to which an electrical potential may be applied.

12. The transistor model of claim 11 and further comprising a voltage source between the gate terminal and gate for applying the electrical potential to the region between the gate terminal and gate.

13. The transistor model of claim 12 wherein the voltage source applies the electrical potential from higher to lower potential in the direction from the gate terminal to the gate.

14. The transistor model of claim 12 wherein the magnitude of the electrical potential is dependent on the magnitude of a voltage applied to the drain of the transistor model.

15. The transistor model of claim 12 wherein the magnitude of the electrical potential is proportional to the magnitude of a voltage applied to the drain of the transistor model.

16. The transistor model of claim 12 wherein the magnitude of the electrical potential is directly proportional to the magnitude of voltage applied to the drain of the transistor model.
